(19) United States
(12) Patent Application Publication
(10) Pub. No.: US 2026/0269549 A1
(43) Pub. Date: Sep. 10, 2026

(54) ELECTRICAL OUTLET EXTENDER

(71) Applicant: Shenzhen Yuechen Technology Co., Ltd, Shenzhen (CN)

(72) Inventor: YUEBO TAO, Eastvale, CA (US)

(21) Appl. No.: 19/663,595

(22) Filed: Apr. 30, 2026

Related U.S. Application Data
(63) Continuation-in-part of application No. 18/425,361, filed on Jan. 29, 2024, now Pat. No. 12,658,658.
Application No. 18/425,361 is a continuation-in-part of application No. 18/139,188, filed on Apr. 25, 2023, now Pat. No. 11,901,685.

(30) Foreign Application Priority Data
Apr. 25, 2022 (CN) 202220962452.8
Feb. 13, 2026 (CN) 202620216450.2

(51) Int. Cl. H01R 39/64; H01R 25/00

(52) U.S. Cl. CPC H01R 39/64; H01R 25/006

(57) ABSTRACT

The present disclosure provides an electrical outlet extender. The electrical outlet extender includes a rotatable electrical plug including a non-rotating assembly; a rotating assembly being rotatable relative to the non-rotating assembly; and at least one rotating conductor connected to the at least one non-rotating element respectively; a receptacle configured to connect an external electrical device; and an extension assembly including at least one extension element configured to detachably connect to the rotatable electrical plug and the receptacle.

### RELATED APPLICATIONS

This application claims the benefit of priority to Chinese Patent Application Number 202620216450.2 filed on Feb. 13, 2026, in CNIPA, and is continuation in part application of application Ser. No. 18/425,361, filed on Jan. 29, 2024, in USPTO, which is continuation in part application of application Ser. No. 18/139,188, filed on Apr. 25, 2023, in USPTO, which claims the benefit of priority to Chinese Patent Application Number 202220962452.8 filed on Apr. 25, 2022, in CNIPA. The entire contents of the above-identified application are hereby incorporated by reference.

### TECHNICAL FIELD

The disclosure relates to the technical field of plugs, and in particular to an electrical outlet extender.

### BACKGROUND

Fixed wall power outlets are often placed in inconvenient or inaccessible locations in homes, offices, and commercial settings, such as behind furniture, sofas, and beds. This makes plugging and unplugging devices difficult and often requires excessively long power cords for televisions, computers, and other electronics. Common extension cords help extend outlet reach but create clutter, pose tripping hazards, and can damage wiring at the wall outlet connection. Accordingly, there exists a need for a wall-mounted power outlet extender that relocates an outlet to a more accessible position without professional electrical work or messy cables.

### BRIEF DESCRIPTION OF DRAWINGS

Implementations of the present disclosure will now be described, by way of embodiment, with reference to the attached figures.

FIG. 1 is a state diagram of an electrical outlet extender mounted on a wall according to a first embodiment of the present disclosure.

FIG. 2 is an exploded view of the electrical outlet extender shown in FIG. 1.

FIG. 3 is a state diagram of the electrical outlet extender mounted on the wall according to another embodiment of the present disclosure.

FIG. 4 is an assembled state diagram of a rotatable electrical plug and a receiving member of a connection assembly shown in FIG. 1.

FIG. 5 is a partial three-dimensional structural view of the rotatable electrical plug shown in FIG. 4.

FIG. 6 is an exploded schematic view of the rotatable electrical plug shown in FIG. 1.

FIG. 7 is an exploded schematic view of the rotatable electrical plug shown in FIG. 6 from another angle.

FIG. 8 is an exploded schematic view of a partial structure of the rotatable electrical plug shown in FIG. 6.

FIG. 9 is an exploded schematic view of a partial structure of the rotatable electrical plug shown in FIG. 6.

FIG. 10 is an exploded schematic view of a partial structure of the rotatable electrical plug shown in FIG. 6.

FIG. 11 is an exploded schematic view of a partial structure of the rotatable electrical plug shown in FIG. 10, viewed from another angle.

FIG. 12 is a cross-sectional view of the rotatable electrical plug and the receiving member of the connection assembly shown in FIG. 4.

FIG. 13 is an exploded view of a receptacle shown in FIG. 2.

FIG. 14 is an exploded view of the receptacle shown in FIG. 2, mounted on the wall.

FIG. 15 is an assembled state diagram of an extension assembly and an insertion member of a second connection assembly shown in FIG. 2.

FIG. 16 is a cross-sectional view of a conversion device of the extension assembly shown in FIG. 2.

FIG. 17 is a three-dimensional structural view of the receiving member of the connection assembly shown in FIG. 4.

FIG. 18 is a three-dimensional structural view of an insertion member of a first connection assembly according to an embodiment of the present disclosure.

FIG. 19 is a three-dimensional structural view of pins of the insertion member shown in FIG. 18.

FIG. 20 is a cross-sectional view of the receiving member and the insertion member of the first connection assembly after connection shown in FIG. 18.

FIG. 21 is a three-dimensional structural view of an electrical outlet extender according to a second embodiment of the present disclosure.

FIG. 22 is a rotation schematic view of the electrical outlet extender shown in FIG. 21.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

The term “comprising” when utilized, means “including, but not necessarily limited to”, specifically indicates open-ended inclusion or membership in the so-described combination, group, series, and the like. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references may mean “at least one”.

### First Embodiment

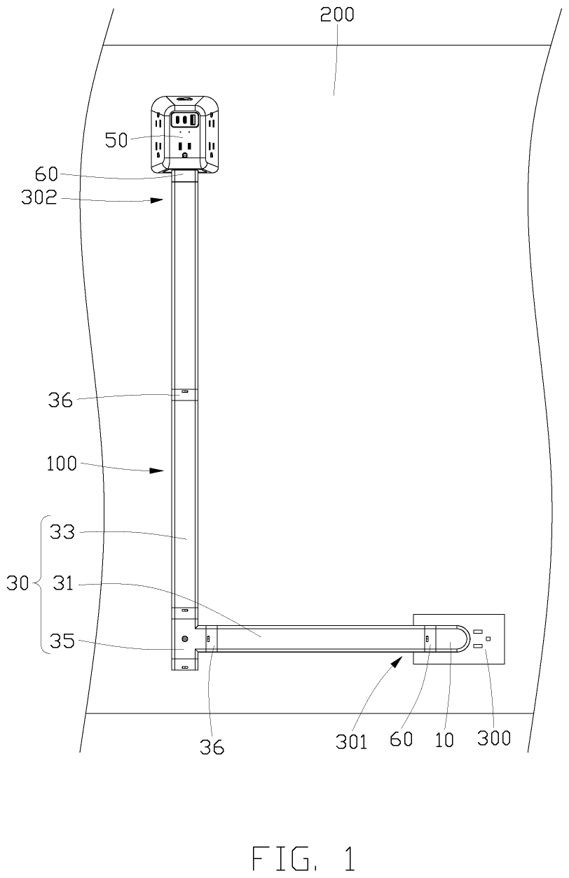

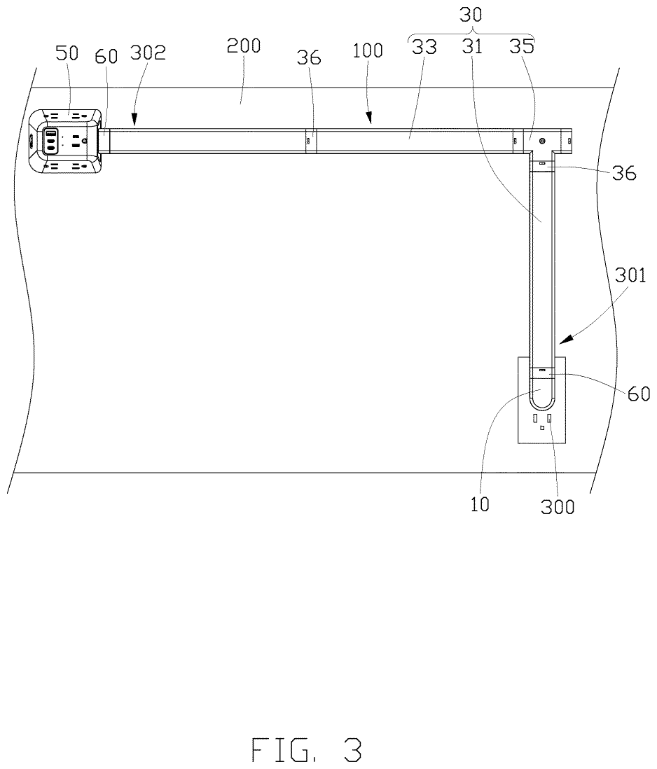

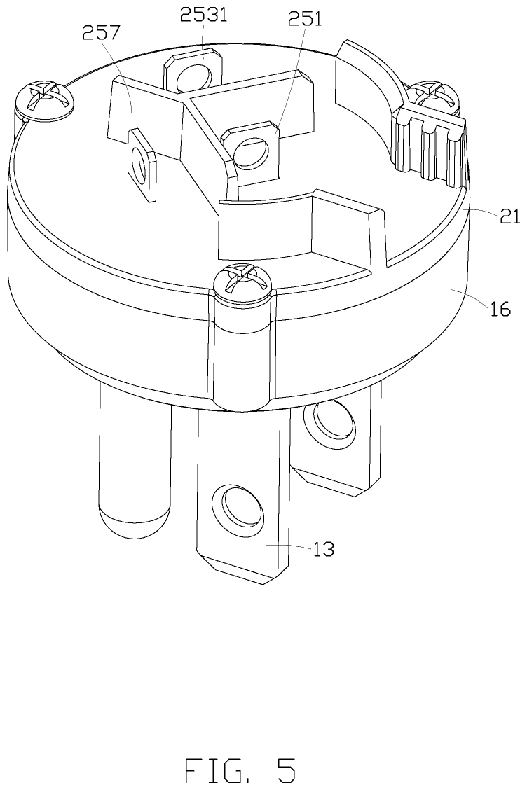

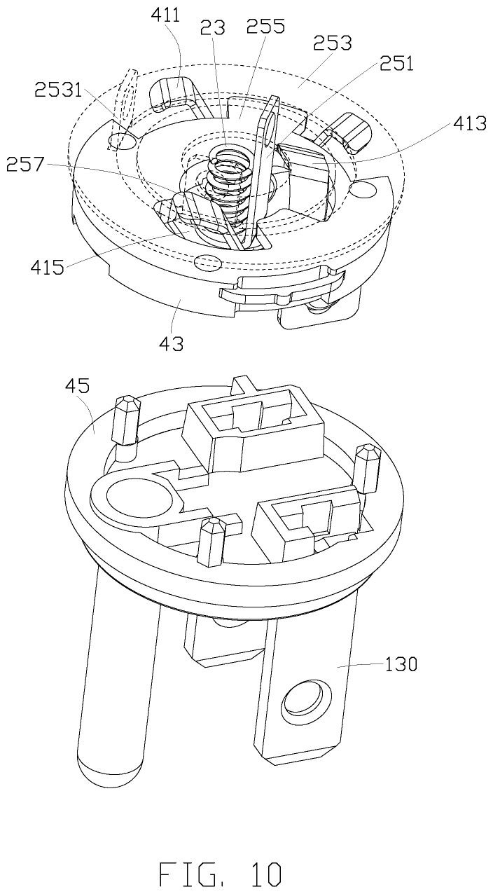

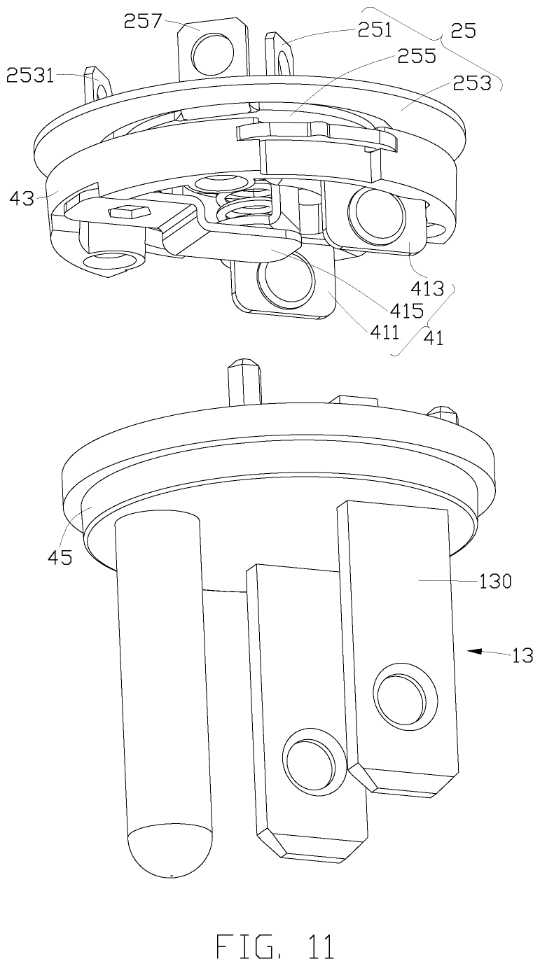

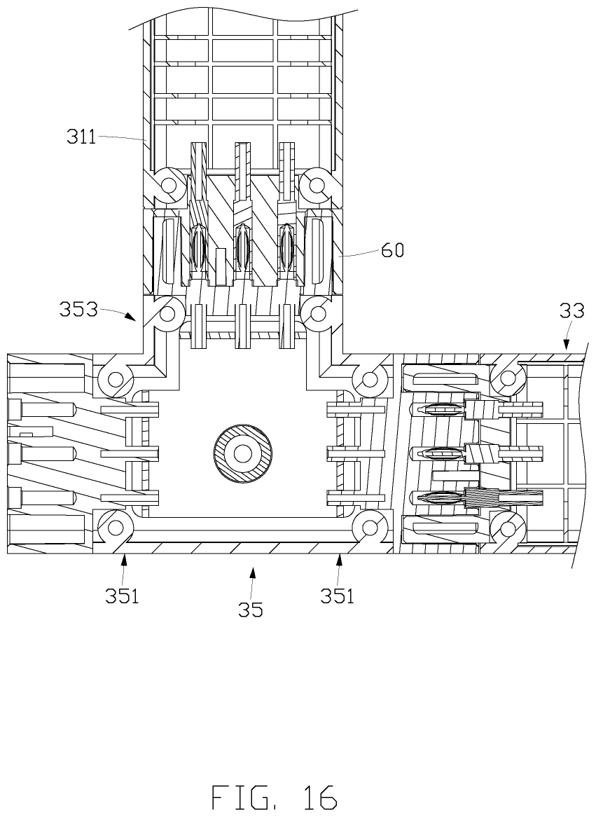

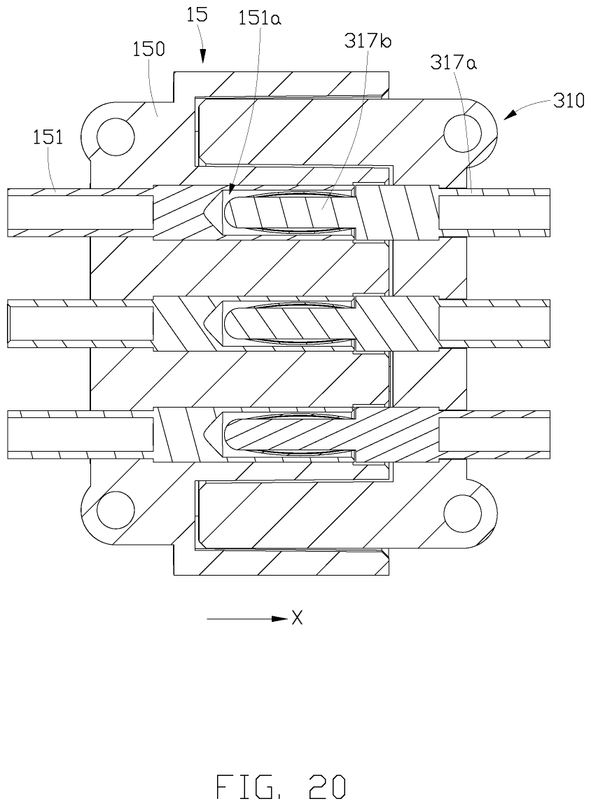

Referring to FIGS. 1 to 20, a first embodiment of the present disclosure provides an electrical outlet extender 100, one end of which is electrically connected to a power socket 300 fixed at an arbitrary position such as a wall or a floor, and the other end of which is electrically connected to an external electrical device (not shown). In this embodiment, the power socket 300 is disposed on a wall 200. When the external electrical device is far away from the power socket 300, or the power socket 300 is located behind a sofa, a bed head and the like resulting in inconvenient plugging and unplugging, the electrical outlet extender 100 can realize electrical connection between the external electrical device and the power socket 300, thereby significantly improving the convenience of use. In addition, the electrical outlet extender 100 in the present embodiment adopts a thin structure, which can be installed in a narrow space between a movable object such as a sofa or a bed and the wall 200, further improving the convenience of use.

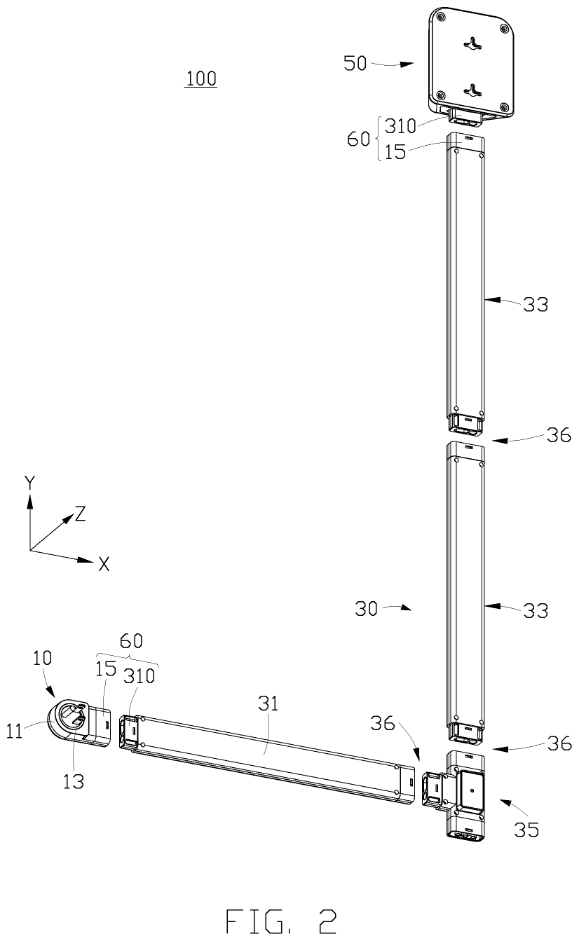

Referring to FIGS. 1 to 2, the electrical outlet extender 100 includes a rotatable electrical plug 10, an extension assembly 30, a receptacle 50, two first connection assemblies 60. Both ends of the extension assembly 30 are detachably connected to the rotatable electrical plug 10 and the receptacle 50 respectively via a corresponding one of the two connection assemblies 60, respectively.

The rotatable electrical plug 10 is electrically connected to the power socket 300 disposed on the wall 200, and one end of the rotatable electrical plug 10 is electrically connected to one end of the extension assembly 30 via a corresponding one of the two connection assemblies 60.

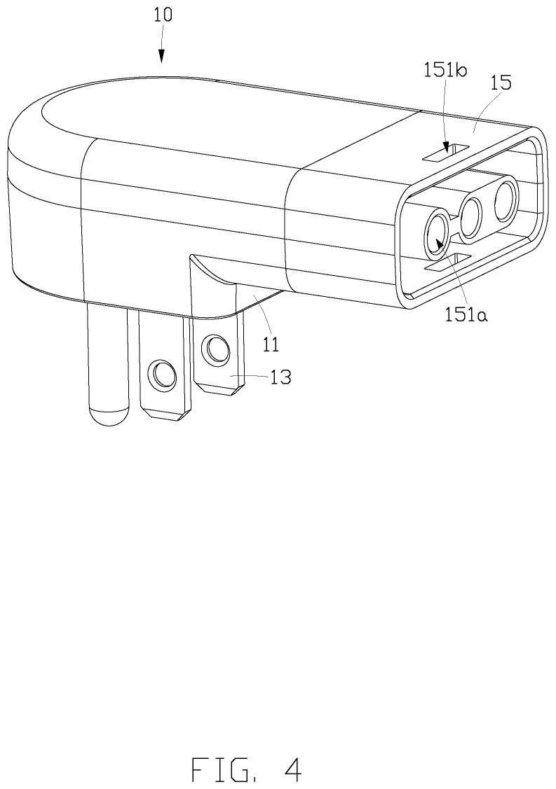

Referring to FIGS. 4 to 11, the rotatable electrical plug 10 comprises a housing 11, a non-rotating assembly 20, a rotating assembly 40, and a frame 16.

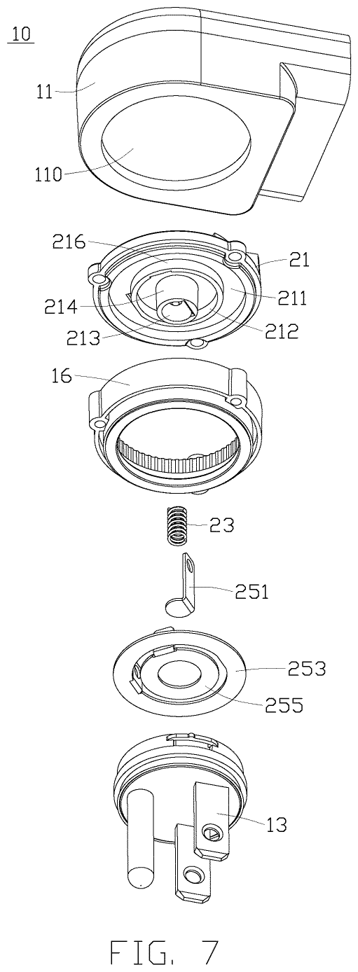

Referring to FIG. 7, the housing 11 comprises a cavity 110 configured to receive the non-rotating assembly 20, the rotating assembly 40, and the frame 16, and the rotating assembly 40 is rotatable through 360 degrees relative to the non-rotating assembly 20 and the housing 11.

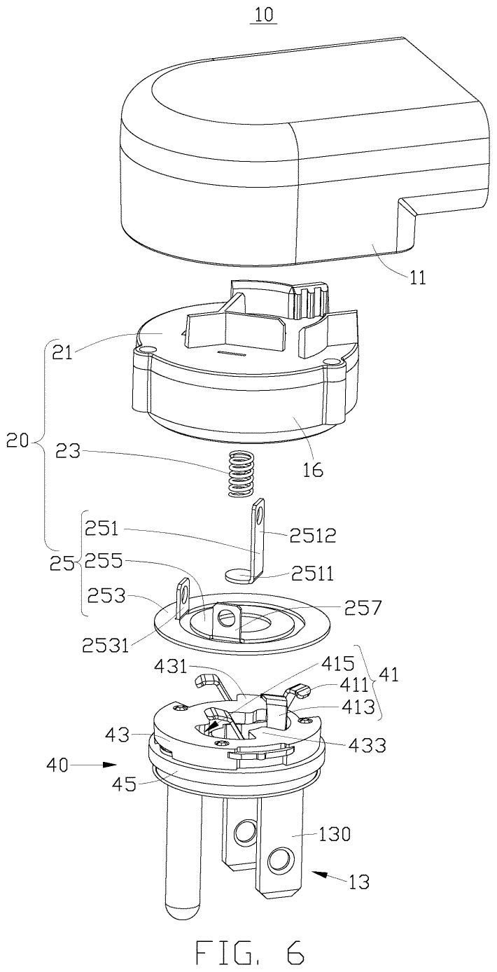

Referring to FIGS. 6 and 7, the non-rotating assembly 20 is configured for receiving and being coupled with power lines of the rotatable electrical plug 10, and comprises a substrate 21, a conductor unit 25 located on the substrate 21, and an elastic member 23.

The substrate 21 comprises a first groove 211, a second groove 212 and a third groove 213. The first groove 211 surrounds the second groove 212, and the second groove 212 surrounds the third groove 213.

In this embodiment, both the first groove 211 and the second groove 212 are circular in shape and a spacer wall 216 is disposed between the first groove 211 and the second groove 212 and integrated with the substrate 21. A first circle defined by the first groove 211 and a second circle defined by the second groove 212 are concentric. The substrate 21 comprises a cylinder 214, the third groove 213 is defined on the cylinder 214 and located in a center of the circles defined by the first groove 211 and the second groove 212. In other embodiments, the first groove 211, the second groove 212 and the third groove 213 can be for example other ring shapes.

The conductor unit 25 comprises a first ring-shaped conductor (an example of non-rotating element) 253, a second ring-shaped conductor (an example of non-rotating element) 255, and a non-rotating conductor (an example of non-rotating element) 251. The first ring-shaped conductor 253, the second ring-shaped conductor 255 and the non-rotating conductor 251 are sequentially arranged at intervals and arranged on the substrate 21. The first ring-shape conductor 253, the second ring-shaped conductor 255 and the non-rotating conductor 251 are correspondingly received in the first groove 211, the second groove 212 and third groove 213 respectively.

The first ring-shaped conductor 253 and the second ring-shaped conductor 255 are in concentric circles, and a diameter of the first ring-shaped conductor 253 is greater than a diameter of the second ring-shaped conductor 255, that is, the second ring-shaped conductor 255 is located an inner side of the first ring-shaped conductor 253. In this embodiment, the first ring-shaped conductor 253 and the second ring-shaped conductor 255 are coplanar. In addition, the first ring-shaped conductor 253 comprises a first fixing portion 2531 passing through the substrate 21 to electrically connect to a corresponding one of the power lines in the rotatable electrical plug 10, the second ring-shaped conductor 255 comprises a second fixing portion 257 passing through the substrate 21 to electrically connect to a corresponding one of the power lines.

The non-rotating conductor 251 is received in the third groove 213 and surrounded by the first ring-shaped conductor 253 and the second ring-shaped conductor 255. The non-rotating conductor 251 comprises a sheet 2511 and a third fixing portion 2512 integrated with the sheet 2511 and passing through the substrate 21 to be electrically connected to a corresponding one of the power lines.

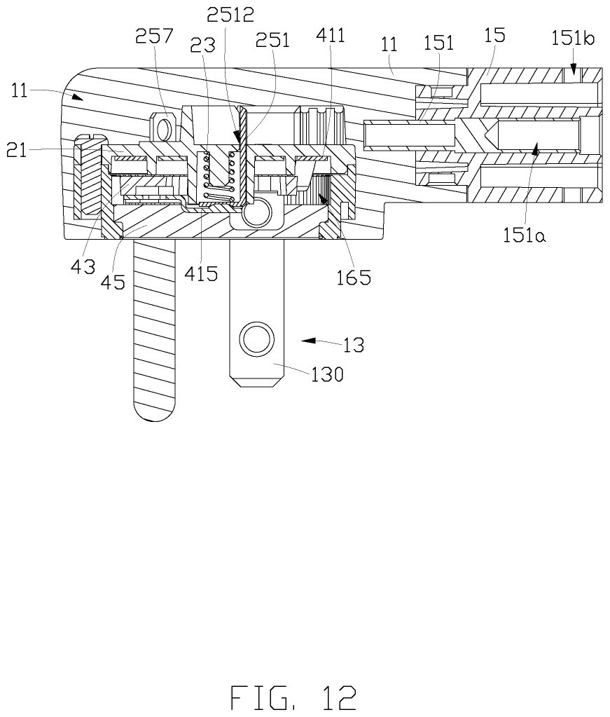

The elastic member 23 is configured for abutting the sheet 2511 of the non-rotating conductor 251 (shown in FIG. 12), so that the sheet 2511 can tightly connect with the third rotating conductor 415 and improve the stability of the connection between the third rotating conductor 415 and the non-rotating conductor 251.

In this embodiment, the sheet 2511 is substantially perpendicular to the third fixing portion 2512, so that the elastic member 23 can better apply elasticity to the sheet 2511, and then the sheet 2511 can tightly connect with the third rotating conductor 415.

In this embodiment, the cylinder 214 can be for example a cylindrical column integrated with the substrate 21, and the elastic member 23 can be for example a spring, the spring is sheathed on the cylindrical column.

Referring to FIGS. 6 to 10, the rotating assembly 40 comprises a terminal unit 13, a conductive unit 41, a fastening element 43, and a plate 45.

In this embodiment, the terminal unit 13 comprises three electrode terminals 130 arranged spaced from each other.

In this embodiment, the three electrode terminals 130 form a set of pins of a three terminal plug, and the set of pins respectively corresponding to one of the live wire, zero wire, and ground wire.

The conductive unit 41 comprises a first rotating conductor 411 connected to the first ring-shaped conductor 253, a second rotating conductor 413 connected to the second ring-shaped conductor 255 and a third rotating conductor 415 connected to the non-rotating conductor 251.

Each electrode terminal of the terminal unit 13 is connected to a corresponding one of the first ring-shaped conductor 253, the second ring-shaped conductor 255 and the non-rotating conductor 251 via a corresponding one of the rotating conductors. In this embodiment, the first rotating conductor 411 and the second rotating conductor 413 are made of copper.

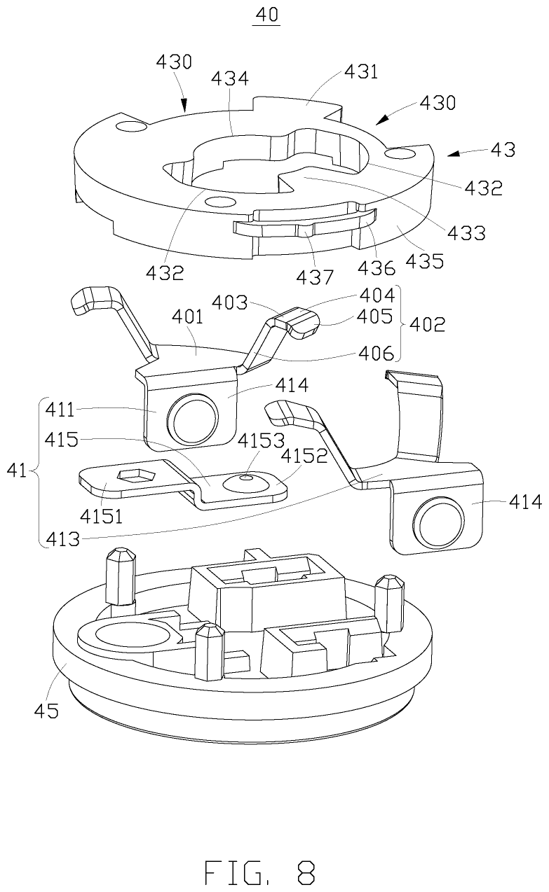

Referring to FIG. 8, at least one of the first rotating conductor 411 and the second rotating conductor 413 comprises a base 401 and two arms 402 extending from the base 401 and extending in two non-parallel directions.

Each arm 402 includes a contacting portion 403 having a contacting surface 404. The contacting surfaces 404 of the two arms 402 contact two different positions of the same ring-shaped conductor, so as to form two electronic contacting points. When one of the contacting portions 403 is damaged by prolonged rotational friction, the rotating conductor can still normally operates because of another contacting point. Each of the contacting surfaces 404 is a flat surface. In the embodiment, an area of the flat surface is 2-5 square millimeters.

Each arm 402 further comprises an extending portion 405 adjacent to a free end of each of the two arms 402, the extending portion 405 connects to the contacting portion 403 and does not contact the corresponding one of the first ring-shaped conductor 253 and the second ring-shaped conductor 255. Due to having the extending portion 405 that is not in contact with the corresponding one of the first ring-shaped conductor and the second ring-shaped conductor, therefore it can prevent the end of the arms 402 from tilting and deforming.

Each arm 402 further comprises a connecting portion 406 obliquely connecting with the base 401 and the contacting portion 403, so that the base 401 and the contacting portion 403 are located on different planar surfaces.

In this embodiment, both the first rotating conductor 411 and the second rotating conductor 413 each comprises the base 401 and the two arms 402, the two arms 402 and at least part of the base 401 of the first rotating conductor 411 form a first arc-like structure, the two arms 402 and at least part of the base 401 of the second rotating conductor 413 form a second arc-like structure, and the second arc-like structure is closer to a center of the rotatable electrical plug 10 compared to the first arc-like structure. The base 401 of the first rotating conductor 411 and the base 401 of the second rotating conductor 413 are coplanar. In addition, both the first rotating conductor 411 and the second rotating conductor 413 each is a metal component with elasticity.

In other embodiments, the first rotating conductor 411 and the second rotating conductor 413 each comprises the base 401 and only one arm 402, which is not limited herein.

A distance between the first rotating conductor 411 and the first ring-shape conductor 253, and a distance between the second rotating conductor 411 and the second ring-shape conductor 255 can be regulated due to its arm structure. That is, the size of the plug can be obtained by regulating these distances.

In addition, each of the first rotating conductor 411 and the second rotating conductor 413 further comprises a mounting portion 414 configured to connect to the corresponding one electrode terminal 130 of the terminal unit 13.

The third rotating conductor 415 is a slice, the slice comprises a first portion 4151 and a second portion 4152. The first portion 4151 is configured to connect to the corresponding one electrode terminal 130 of the terminal unit 13, and the second portion 4152 is closer to a center of the plate 45 compared to the first portion 4151. The first portion 4151 and the second portion 4152 are located on different planar surfaces. The third rotating conductor 415 further comprises a contact 4153 configured to connect to the non-rotating conductor 251 and arranged on the second portion 4152.

The fastening element 43 is configured for fixing the conductive unit 41 to the plate 45, the detailed structure will be described later. The fastening element 43 is mounted on the plate 45, the fastening element 43 comprises notches corresponding to the arms 402 and a spacer formed between two adjacent notches arranged in a circumferential direction, the arms 402 expose outside via the corresponding notch, and the spacer is disposed to sandwich the base 401 with the plate 45.

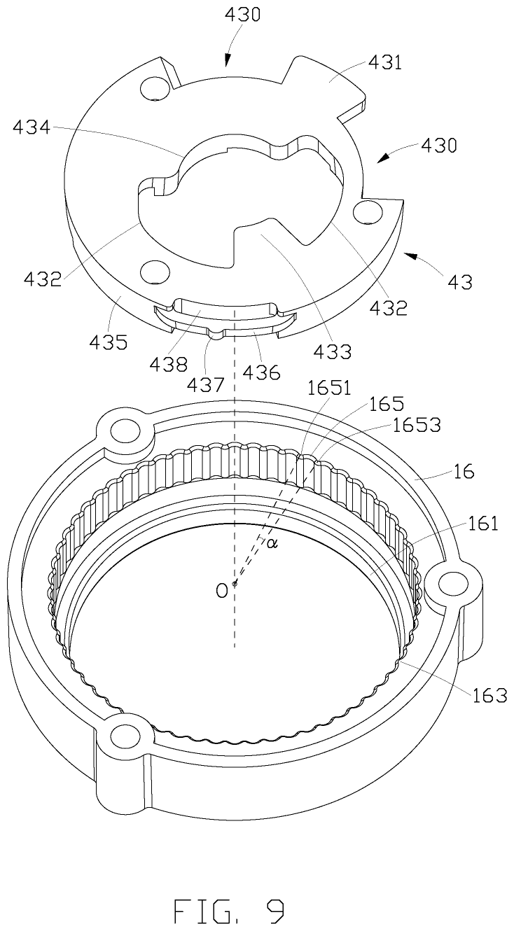

In this embodiment, referring to FIGS. 8 and 9, the fastening element 43 comprises two first notches 430 located at an edge of the fastening element 43 and a first spacer 431 located between the two first notches 430, the first spacer 431 is engaged with the base 401 of the first rotating conductor 411, and each of the two arms 402 of the first rotating conductor 411 is penetrated through the corresponding one of the two first notches 430.

The fastening element 43 further comprises two second notches 432 and a second spacer 433 located between the two second notches 432, the second spacer 433 is engaged with the base 401 of the second rotating conductor 413, and each of the two arms 402 of the second rotating conductor 413 is penetrated through the corresponding one of the two second notches 432.

In this way, the fastening element 43 further fixes the first rotating conductor 411 and the second rotating conductor 413 on the plate 45, making the first rotating conductor 411 and the second rotating conductor 413 not easily deformable, which can effectively improve the stability of the rotatable electrical plug 10 during use.

In addition, the first spacer 431 and the second spacer 433 are arranged in a staggered manner. Specifically, the first spacer 431 and the second spacer 433 are configured to be asymmetric relative to a central axis of the fastening element 43.

In this embodiment, the first spacer 431 protrudes towards a direction away from a center of the fastening element 43, and the second spacer 433 protrudes towards the center of the fastening element 43.

Due to the staggered setting of the first spacer 431 and the second spacer 433, it can reduce the overall area and the volume of the rotatable electrical plug 10.

In addition, the fastening element 43 further comprises a hole 434 configured to allow the third rotating conductor 415 to pass through. In this embodiment, the hole 434 is in air communication with the two second notches 432. In other embodiments, the hole 434 and the two second notches 432 can also be disconnected, and there is no limitation here.

By setting such the fastening element 43, the first rotating conductor 411 and the second rotating conductor 413 can be stably fixed, effectively preventing the first rotating conductor 411 and the second rotating conductor 413 from shifting and deforming during rotation, further avoiding electrical contact between the first rotating conductor 411 and the second rotating conductor 413, and effectively improving the safety of use.

In this embodiment, a height between the contacting portion 403 and the base 401 is greater than a thickness of the fastening element 43, so that the contacting portion 403 is exposed to an exterior via the corresponding notch and connects to the corresponding ring-Shaped conductor.

The fastening element 43 further comprises a side wall 435 extending along a circumferential direction of the fastening element 43, an elastic portion 436 arranged on the side wall 435, and a rib 437 arranged on the elastic portion 436.

The elastic portion 436 extends along the circumferential direction of the fastening element 43 and both ends of the elastic portion 436 are connected to the fastening element 43, and the other parts of the elastic portion 436 do not contact with the fastening element 43, thereby making the elastic portion 436 having a certain elasticity.

In this embodiment, the rib 437 protrudes from a center of the elastic portion 436 and extends along a height direction of the elastic portion 436. In other embodiments, the rib 437 can be other structure, which is not limited herein.

In addition, in this embodiment, the fastening element 43 further comprises a recess 438 defined on the side wall 435 of the fastening element 43 corresponding to the elastic portion 436, so as to provide a sufficient space for the deformation of the elastic portion 436 when the rotating assembly 40 rotates relative to non-rotating assembly 20.

Referring to FIGS. 7 and 9, the frame 16 configured to fasten the non-rotating assembly 20 and pivotally fixed the rotating assembly 40 is shown. The frame 16 comprises an opening 161 configured for allowing the rotating assembly 40 to pass rotatably through the opening 161.

The frame 16 further comprises an inner wall 163 facing towards the side wall 435 of the fastening element 43, and a plurality of recessed portions 165 defined on the inner wall 163. The plurality of recessed portions 165 are arranged along a circumferential direction of the inner wall 163 and each extends along a height direction of the frame 16. The rib 437 is configured to be insertable into the corresponding one of the recessed portions 165 during rotation.

Since the rib 437 is always inserted into one of the plurality of recessed portions 165, the position of the rotating assembly 40 relative to the non-rotating assembly 20 is fixed without applying force, and it is not easy for the rotating assembly 40 to rotate relative to the non-rotating assembly 20 during use, and therefore making the rotating feel better and improving the user experience.

In this embodiment, the plurality of recessed portions 165 are continuously defined on the inner wall 163, each of the plurality of recessed portions 165 comprises a first end 1651 and a second end 1653, an angle α formed by a line connecting the first end 1651 and a center O of the frame 16 and a line connecting the second end 1653 and the center O of the frame 16 ranges from about 3° to 6°.

In other embodiments, the plurality of recessed portions 165 are distributed at intervals, and when the rotating assembly 40 rotates to a specific position relative to the non-rotating assembly 20, the rib 437 can be inserted into the corresponding one of the plurality of recessed portions 165, so that the position of the rotating assembly 40 relative to the non-rotating assembly 20 is fixed without applying force.

In this embodiment, a cross-sectional shape of the plurality of recessed portions 165 can be for example a circular arc shape, and the rib 437 has a circular arc shape that matches the plurality of recessed portions 165. In this way, the plurality of recessed portions 165 can serve as guide grooves, guiding the rib 437 to be inserted into the corresponding one of the plurality of recessed portions 165.

In other embodiments, the cross-sectional shape of the plurality of recessed portions 165 can be for example a triangle or other shape, which is not limited herein.

In addition, a depth and a width of the plurality of recessed portions 165, as well as a height and a width of the rib 437 can be adjusted appropriately according to the needs, which is not limited herein.

During assembly of the rotatable electrical plug 10, the rotating assembly 40 is engaged with one end of the frame 16, and the non-rotating assembly 20 is fitted over the opposite end of the frame 16. The rotating assembly 40, the non-rotating assembly 20, and the frame 16 are then inserted into the cavity 110 of the housing 11. The rotating assembly 40, the non-rotating assembly 20, the frame 16, and the housing 11 are secured together, with the electrode terminals extending outward from the frame 16 for inserting into the power socket 300. Additionally, the rotating assembly 40 is rotatable relative to the non-rotating assembly 20, thereby improving ease of use. The rotatable electrical plug 10 features a simple structure while exhibiting excellent electrical conductivity and durability.

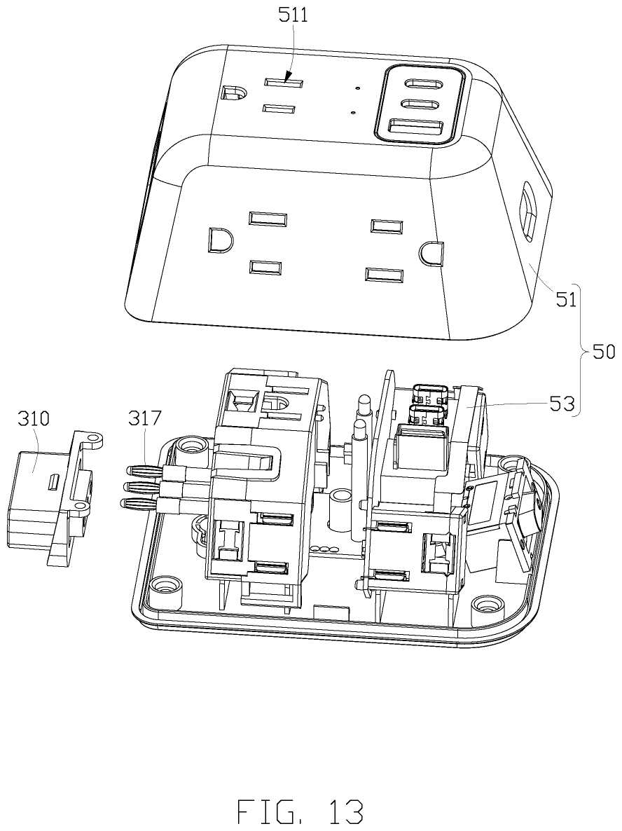

Referring to FIG. 13, the receptacle 50 includes a casing 51 and an electronic component 53. The electronic component 53 is accommodated inside the casing 51, and a plurality of insertion holes 511 are formed on a surface of the casing 51 and configured for allowing a plug of an external electrical device to insert into.

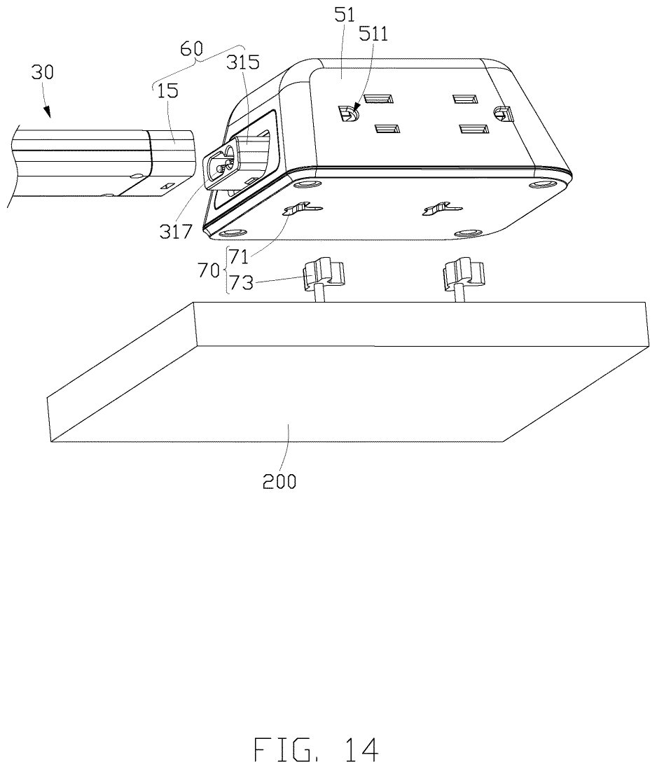

Referring to FIG. 14, one end of the receptacle 50 is detachably connected to the extension assembly 30 via the first connection assembly 60, and is fixed to the wall 200 via a mounting assembly 70. The mounting assembly 70 includes a first connection portion 71 and a second connection portion 73. The first connection portion 71 is disposed on a back surface of the casing 51, and the second connection portion 73 is disposed on the wall 200 detachably connected to the second connection portion 73, thereby fixing the receptacle 50 to the wall 200. In the present embodiment, the first connection portion 71 includes at least one opening formed at a bottom of the receptacle 50, and the second connection portion 73 includes at least one nail inserted into the corresponding opening to fix the receptacle 50 to the wall 200.

In another embodiment, the first connection portion 71 and the second connection portion 73 may be patches with bonding function such as Velcro, which is not particularly limited herein.

The extension assembly 30 is coupled to the non-rotating assembly 20, and rotatable relative to the rotating assembly 40 in response to the non-rotating assembly 20 been rotated. The extension assembly 30 includes a first connecting end 301 and a second connecting end 302. The first connecting end 301 is detachably connected to the rotatable electrical plug 10 via a corresponding one of the two connection assemblies 60, and the second connecting end 302 is detachably connected to the receptacle 50 via the other one of the two first connection assemblies 60.

The extension assembly 30 includes at least one first extension element 31, at least one second extension element 33, a conversion device 35 and at least two second connection assemblies 36. Each of at least two extension elements are detachably connected to the conversion device 35 via a corresponding one of the at least two second connection assemblies 36.

One end of the at least one first extension element 31 is detachably connected to the rotatable electrical plug 10 via a corresponding one of the two first connection assemblies 60, and the other end of the at least one first extension element 31 is detachably connected to the conversion device 35 via a corresponding one of the at least two second connection assemblies 36, one end of the at least one second extension element 33 is detachably connected to the receptacle 50 via a corresponding one of the two first connection assemblies 60, and the other end of the at least one second extension element 33 is detachably connected to the conversion device 35 via a corresponding one of the at least two second connection assemblies 36. Moreover, an extending direction of the first extension element 31 is different from an extending direction of the second extension element 33, so that a position of the receptacle 50 a can be achieved by adjusting an included angle between the extending direction of the first extension element 31 and the extending direction of the second extension element 33 and rotating the rotatable electrical plug 10. In the present embodiment, the extending directions of the first extension element 31 and the second extension element 33 are perpendicular to each other, in other embodiments, they may also be arranged at an acute angle or an obtuse angle, which is not limited herein.

In the present embodiment, the extension assembly 30 includes one first extension element 31 and two second extension elements 33, the two second extension elements 33 are connected via a corresponding one of the at least two second connection assemblies 36 and extending linearly. A user may adjust the number of the first extension elements 31 and the second extension elements 33 according to actual needs. The structure of the second connection assembly 36 is the same as that of the first connection assembly 60, and thus a description of the second connection assembly 36 thereof is omitted.

The first extension element 31 and the second extension element 33 have the same structure, and the following description is given by taking the first extension element 31 as an example. Referring to FIG. 14, the first extension element 31 includes an upper housing 311 and a lower housing 312 cooperatively connected with the upper housing 311, and electric wires are arranged between the upper housing 311 and the lower housing 312. At least one end of the upper housing 311 and at least one end of the lower housing 312 on a same side are connected to the first connection assembly 60 or the second connection assembly 36. Thus, even if the upper housing 311 or the lower housing 312 of the extension element falls off after long-term use of the electrical outlet extender 100, the electric wires can still be stably connected to the first connection assembly 60 and the second connection assembly 36 at both ends without falling off along with the upper housing 311 or the lower housing 312.

Further, the first extension element 31 and the second extension element 33 are relatively thin. As long as a distance between a movable object such as a bed or a sofa and the wall 200 is greater than a thickness of the extension assembly 30, the extension assembly 30 can be installed therebetween, so that the electrical outlet extender 100 does not occupy excessive space. In the present embodiment, the thickness of the first extension element 31 or the second extension element 33 ranges from 1 cm to 2 cm, so a reserved distance of 2 cm between the movable object and the wall 200 can meet the installation requirement.

The conversion device 35 is disposed between the first extension element 31 and the second extension element 33, so that the rotatable electrical plug 10 and the receptacle 50 are arranged non-collinearly.

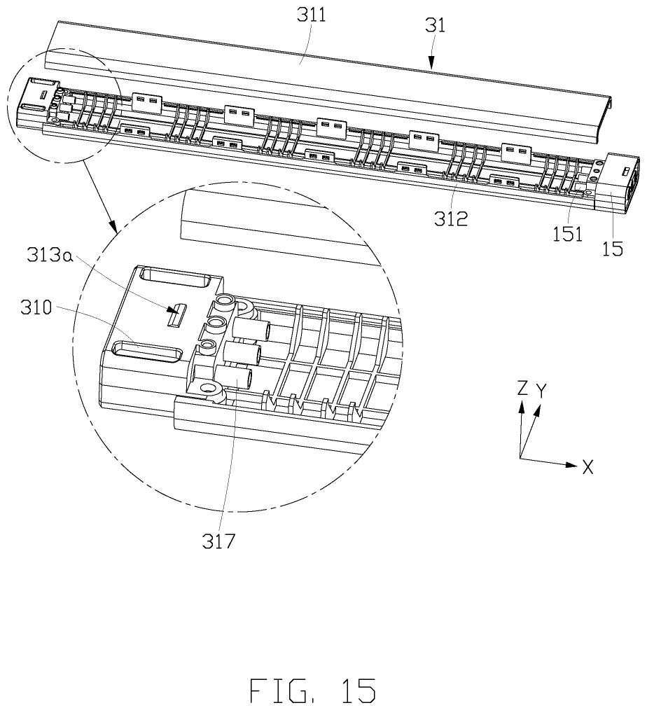

Referring to FIG. 15, the conversion device 35 includes at least one receiving end 351 and at least one plugging end 353. The receiving end 351 is configured to be cooperatively connected with a receiving member 15 of the second connection assembly 36, and the plugging end 353 is configured to be cooperatively connected with an insertion member 310 of the second connection assembly 36. A user may connect the extension elements to the corresponding receiving ends 351 and plugging ends 353 as needed.

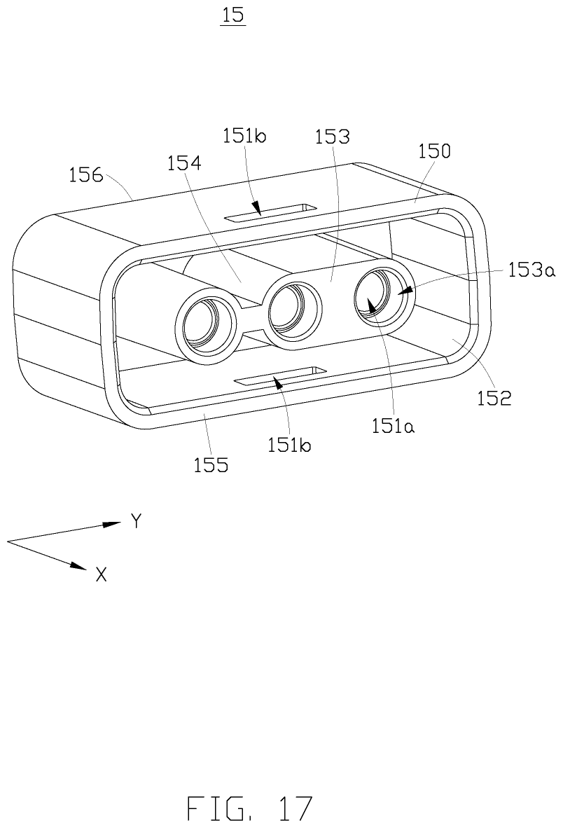

Referring to FIGS. 17 to 20, each first connection assembly 60 includes the insertion member 310 and the receiving member 15 detachably connected to the insertion member 310, thereby realizing detachable connection of the extension assembly 30 with the rotatable electrical plug 10 and the receptacle 50 respectively.

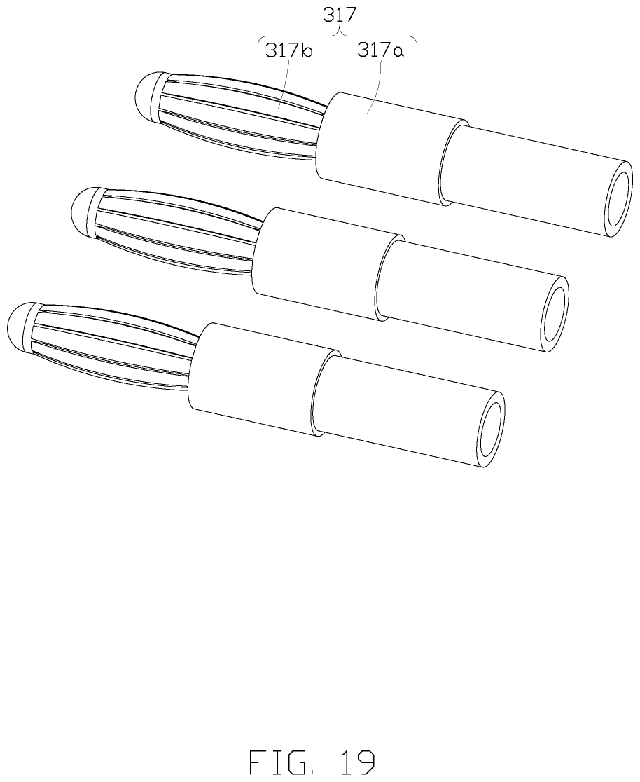

Referring to FIGS. 17 and 19, the receiving member 15 includes a first main body 150 and at least two receiving posts 151, the first main body 150 defines a receiving cavity 152 and includes an installation portion 153 extending along a first direction X and defining at least two installation holes 153a, each of the at least two installation holes 153a is configured for receiving a part of the receiving posts 151. The at least two installation holes153a are arranged at intervals along a second direction Y which is perpendicular to the first direction X.

One end of each receiving post 151 defines a receiving hole 151a, and the at least two receiving holes 151a are arranged in a straight line at intervals along a second direction Y, that is a width direction of the first connection assembly. The other end of each receiving post 151 is electrically connected to the power line.

In the present embodiment, the receiving member 15 includes three receiving posts 151 arranged in the straight line at intervals along the second direction Y. In other embodiments, two receiving posts 151 may also be provided, which is not limited herein.

Further, a pair of concave portions 154 are arranged outside a side wall of the installation portion 153 and arranged opposite to each other.

The receiving member 15 includes a first side wall 155 and a second side wall 156 arranged opposite to the first side wall 155, and each of the first side wall 155 and the second side wall 156 defines an engaging hole 151b.

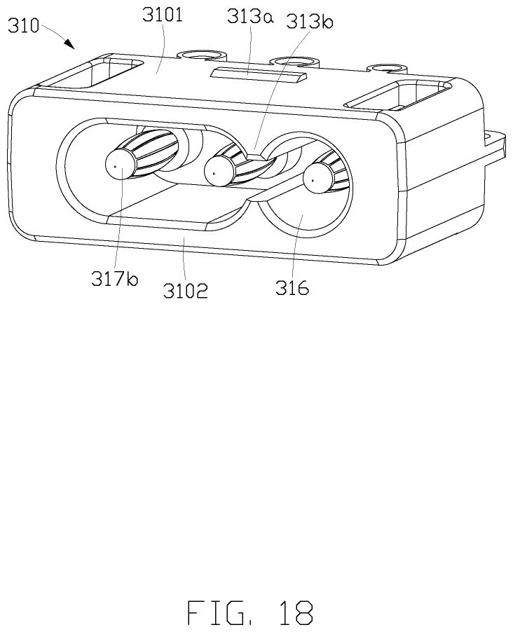

Referring to FIGS. 18 to 19, the insertion member 310 is detachably inserted into the receiving cavity 152 of the receiving member 15, and fixedly disposed on the extension assembly 30, the receptacle 50, or the conversion device 35. The insertion member 310 defines an accommodating cavity 316 and includes at least two pins 317. At least part of the at least two pins 317 are disposed in the accommodating cavity 316 and arranged in one-to-one correspondence with the at least two receiving holes 151a. The accommodating cavity 316 is configured to accommodate the installation portion 153.

Each pin 317 includes a connecting portion 317a and an insertion portion 317b connected to the connecting portion 317a. An outer side wall of the insertion portion 317b is arc-shaped and elastically contacts an inner wall of the receiving hole in a case that the insertion portion 317b is inserted into the corresponding receiving hole 151a. An end of the connecting portion 317a away from the insertion portion 317b is connected to the electric wire.

The insertion portion 317b has elasticity, and the outer side wall of the insertion portion 317b is a convex elliptical arc structure. When the insertion portion 317b is inserted into the receiving hole 151a of the receiving post 151, an outer sidewall of the insertion portion 317b elastically deforms and closely fits an inner wall of the receiving hole 151a, and a front end of the insertion portion 317b away from the connecting portion 317a abuts against a bottom of the receiving hole 151a, so that the insertion portion 317b is tightly fitted with the receiving post 151 and is not easy to loosen. At the same time, the outer sidewall of the insertion portion 317b closely fits the inner wall of the receiving hole 151a, increasing the contact area between the pin 317 and the receiving post 151. Compared with conventional electrode pins, it can carry a larger current, such as 15A.

In other words, the insertion portion 317b has a convex arc contact surface, which elastically contacts the inner wall of the receiving hole 151a of the receiving post 151, thereby not only increasing the contact area but also realizing elastic tight fitting, preventing the insertion portion 317b from disengaging from the receiving post 151 during use.

The insertion member 310 includes a third side wall 3101 and a fourth side wall 3102 arranged opposite to the third side wall 3101, and two latching portions 313a arranged on the third side wall 3101 and the fourth side wall 3102, and the latching portions 313a is configured to latch into the corresponding engaging hole 151b to realize detachable connection between the insertion member 310 and the receiving member 15.

A side wall of the insertion member 310 is disposed around the accommodating cavity 316, and convex portions 313b are arranged on sides of the opposite upper and lower side walls facing the accommodating cavity 316. The convex portions 313b are engaged with the concave portions 154 of the installation portion 153, so that the connection between the insertion member 310 and the receiving member 15 is more stable and less prone to displacement. The number of the convex portions 313b and concave portions 154 may be one, three, or other suitable numbers.

When using the electrical outlet extender 100, it is only necessary to insert the terminal unit 13 of the rotatable electrical plug 10 into the power socket 300 at any position, and the receptacle 50 can be placed at a predetermined position by rotating the rotatable electrical plug 10 and adjusting the length of the extension assembly 30 as required.

### Second Embodiment

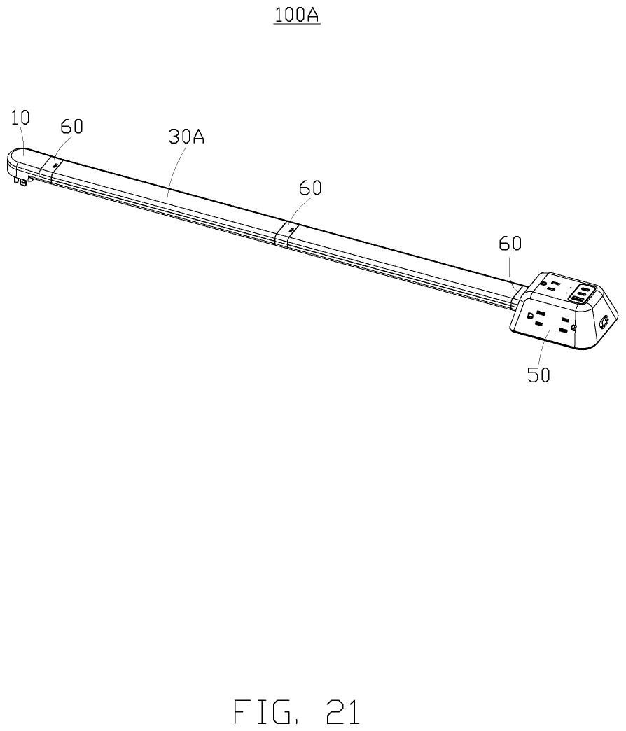

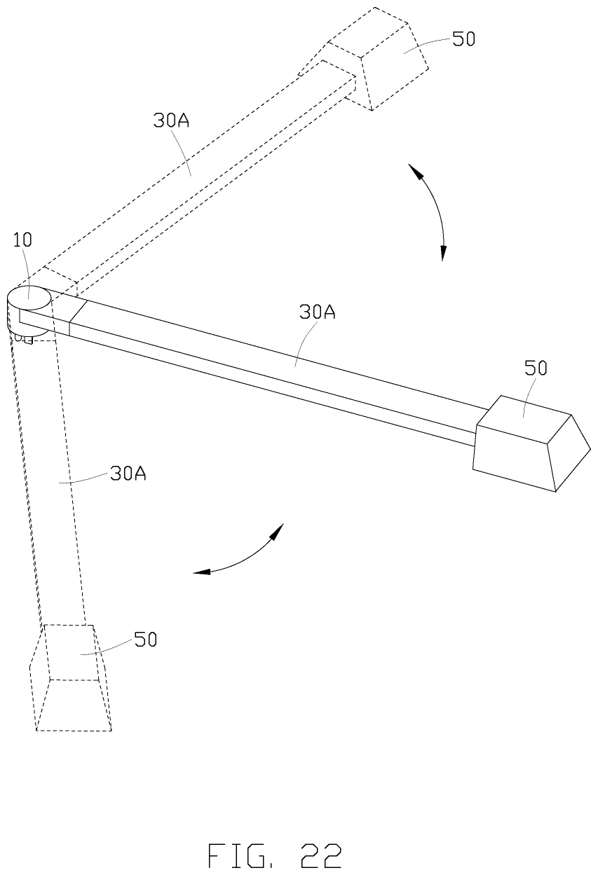

FIGS. 21 to 22 illustrate a second embodiment of electrical outlet extender 100A. For the convenience of explanation, the components with the same functions as those described in the above embodiments are labeled with the same reference numerals, and their explanations are omitted.

Referring to FIG. 21, the electrical outlet extender 100A of the present embodiment differs from the electrical outlet extender 100 of the first embodiment in that the extension assembly 30A does not include a conversion device. The remaining components are identical to those of the first embodiment and will not be described again herein.

Referring to FIG. 22, by rotating the rotatable electrical plug 10, the receptacle 50 may be correspondingly adjusted to a predetermined position as required. Therefore, based on the above composition, it can achieve the same effect as the first embodiment mentioned above.

What is claimed is:

1. An electrical outlet extender comprising:
a rotatable electrical plug comprising:
a non-rotating assembly configured for receiving and coupled with power lines of the rotatable electrical plug, the non-rotating assembly comprising a substrate and at least one non-rotating element;
a rotating assembly rotatable relative to the non-rotating assembly, the rotating assembly comprising at least two electrode terminals configured to electrically plug into a power socket; and at least one rotating conductor connected to the at least one non-rotating element respectively, the at least one rotating conductor comprising a base and at least one arm obliquely extending from the base; and
a fastening element mounted on the rotating assembly and configured for fixing the at least one rotating conductor, the fastening element comprising a first notch opened in a side wall of the fastening element, wherein the at least one arm extends through the first notch to expose outside of the fastening element;
a receptacle configured to connect an external electrical device; and
an extension assembly comprising at least one extension element configured to detachably connect to the rotatable electrical plug and the receptacle, wherein the extension assembly is coupled to the non-rotating assembly, and rotatable relative to the rotating assembly in response to the non-rotating assembly been rotated.

2. The electrical outlet extender according to claim 1, further comprising at least two connection assemblies, wherein one of the at least two connection assemblies is arranged between one end of the extension assembly and the rotatable electrical plug, another one of the at least two connection assemblies is arranged between another end of the extension assembly and the receptacle,
each of the at least two connection assemblies comprises a receiving member and an insertion member detachably coupled to the receiving member, the rotatable electrical plug and the receptacle are detachably connected to the extension assembly via a corresponding connection assembly of the at least two connection assemblies, respective.

3. The electrical outlet extender according to claim 2, wherein the receiving member defines at least two receiving holes, the insertion member comprises at least two pins insertable into the at least two receiving holes, respectively, and the at least two pins and the at least two receiving holes are arranged spaced apart in a straight line along a width direction of the connection assembly.

4. The electrical outlet extender according to claim 3, wherein
each of the at least two pins comprises an insertion portion insertable into a corresponding receiving hole of the at least two receiving holes, and an outer surface of the insertion portion is arc-shaped and elastically contacts an inner wall of the receiving hole in a case that the insertion portion is inserted into the corresponding receiving hole.

5. The electrical outlet extender according to claim 3, wherein
the receiving member further defines a receiving cavity and comprises at least two receiving posts arranged along a first direction perpendicular to the width direction of the connection assembly and electrically connected to the rotatable electrical plug, each of the at least two receiving holes is defined in one end of a corresponding receiving post of the at least two receiving posts, each of the at least two receiving holes extends along the first direction,
the insertion member is insertable into the receiving cavity, and in a case that the at least two pins are inserted into the at least two receiving holes, respectively, the insertion member is electrically connected to the receiving member.

6. The electrical outlet extender according to claim 5, wherein the receiving member further comprises an installation portion defining at least two installation holes configured to receive the at least two receiving posts, respectively, the installation portion comprises at least one concave portion arranged on an outer sidewall of the installation portion; and
the insertion member comprises an accommodating cavity configured for receiving the installation portion and a cavity wall surrounding the accommodating cavity, the cavity wall comprises at least one convex portion configured to engage with the at least one concave portion of the installation portion.

7. The electrical outlet extender according to claim 2, wherein
the extension assembly comprises at least two extension elements and a conversion device comprising at least one receiving end detachably connected to one extension element of the at least two extension elements via connection assembly of the at least two connection assemblies; and at least one plugging end detachably connected to another extension element of the at least one extension element via another connection assembly of the connection assemblies, an extending direction of the extension element connected to the receiving end is different from an extending direction of the other extension element connected to the plugging end.

8. The electrical outlet extender according to claim 2, wherein each of the at least one extension element comprises an upper housing and a lower housing coupled to the upper housing, electric wires are arranged between the upper housing and the lower housing, at least one end of the upper housing and at least one end of the lower housing on a same side of a corresponding extension element of the at least one extension element are connected to the receiving member or connected to the insertion member.

9. The electrical outlet extender according to claim 1, wherein
the at least one non-rotating element comprises a first ring-shaped conductor and a second ring-shaped conductor spaced from the first ring-shaped conductor,
the at least one rotating conductor comprises a first rotating conductor and a second rotating conductor connected to the first ring-shaped conductor and the second ring-shaped conductor respectively, each of the first rotating conductor and the second rotating conductor comprising a base and at least one arm extending from the base; and wherein
the fastening element further comprises a first spacer adjacent to the first notch, a second notch opened in the side wall of the fastening element and a second spacer adjacent to the second notch, the first spacer and the second spacer arranged in a staggered manner.

10. The electrical outlet extender according to claim 9, wherein the non-rotating assembly further comprises a non-rotating conductor arranged on the substrate and an elastic member, the first ring-shaped conductor, the second ring-shaped conductor and the non-rotating conductor are sequentially arranged at intervals, and the non-rotating conductor is surrounded by the second ring-shaped conductor; and wherein
the at least one rotating conductor further comprises a third rotating conductor electrically connected to the non-rotating conductor, the substrate comprises a groove configured for receiving the non-rotating conductor, the non-rotating conductor comprises a sheet contacted with the third rotating conductor and a fixing portion integrated with the sheet, one end of the fixing portion extends through the substrate and is fixed on the substrate, and
the elastic member is arranged in the groove and abuts the sheet of the non-rotating conductor.

11. An electrical outlet extender comprising:
a rotatable electrical plug comprising:
a non-rotating assembly configured for receiving and coupled with power lines of the rotatable electrical plug;
a rotating assembly rotatable relative to the non-rotating assembly, the rotating assembly comprising at least two electrode terminals configured to electrically plug into a power socket;
a receptacle configured to connect an external electrical device;
an extension assembly comprising at least one extension element configured to detachably connect to the rotatable electrical plug; and
at least two connection assemblies, one of the at least two connection assemblies arranged between one end of the extension assembly and the rotatable electrical plug, and another one of the at least two connection assemblies arranged between another end of the extension assembly and the receptacle, respectively,
wherein each of the at least two connection assemblies comprises a receiving member and an insertion member detachably coupled to the receiving member, the receiving member comprises at least two receiving holes, the insertion member comprises at least two pins insertable into the at least two receiving holes, respectively, and the at least two pins and the at least two receiving holes are arranged spaced apart in a straight line along a width direction of the connection assembly.

12. The electrical outlet extender according to claim 11, wherein
each of the at least two pins comprises an insertion portion insertable into a corresponding receiving hole of the at least two receiving holes, and an outer surface of the insertion portion is arc-shaped and elastically contacts an inner wall of the receiving hole in a case that the insertion portion is inserted into the corresponding receiving hole.

13. The electrical outlet extender according to claim 11, wherein
the receiving member further defines a receiving cavity and comprises at least two receiving posts arranged along a first direction perpendicular to the width direction of the connection assembly and electrically connected to the rotatable electrical plug, each of the at least two receiving holes is defined in one end of a corresponding receiving post of the at least two receiving posts, each of the at least two receiving holes extends along the first direction,
the insertion member is insertable into the receiving cavity, and in a case that the at least two pins is inserted into the at least two receiving holes, respectively, the insertion member is electrically connected to the receiving member.

14. The electrical outlet extender according to claim 13, wherein
the receiving member further comprises an installation portion defining at least two installation holes configured to receive the at least two receiving posts, respectively,
the installation portion comprises at least one concave portion arranged on an outer sidewall of the installation portion,
the insertion member comprises an accommodating cavity configured for receiving the installation portion and a cavity wall surrounding the accommodating cavity, the cavity wall comprises at least one convex portion configured to engage with the at least one concave portion of the installation portion.

15. The electrical outlet extender according to claim 11, wherein the extension assembly comprises at least two extension elements, and a conversion device comprising at least one receiving end detachably connected to one extension element of the at least two extension element via the connection assembly of the at least two connection assemblies; and at least one plugging end detachably connected to another extension element of the at least one extension element via the connection assembly, an extending direction of the extension element connected to the receiving end is different from an extending direction of the other extension element connected to the plugging end.

16. The electrical outlet extender according to claim 11, wherein each of the at least one extension element comprises an upper housing and a lower housing coupled to the upper housing, electric wires are arranged between the upper housing and the lower housing, at least one end of the upper housing and at least one end of the lower housing on a same side of a corresponding extension element of the at least one extension element are connected to the receiving member or the insertion member.

17. The electrical outlet extender according to claim 11, wherein the rotatable electrical plug further comprises:
a frame configured for fastening the non-rotating assembly and pivotally fixing the rotating assembly, the frame comprising an inner wall and a plurality of recessed portions defined on the inner wall of the frame, the plurality of recessed portions arranged along a circumferential direction of the inner wall and extending along a height direction of the frame; and
a fastening element mounted on the rotating assembly and comprising a side wall facing towards the inner wall of the frame, and a rib arranged on the side wall and insertable into one recessed portion of the plurality of recessed portions, in a case that the rotating assembly been rotated, the rib is inserted into a recessed portion of the plurality of recessed portions.

18. The electrical outlet extender according to claim 17, wherein the fastening element further comprises an elastic portion arranged on a side wall of the fastening element and extending along a circumferential direction of the fastening element, each end of the elastic portion is connected to the fastening element, and the rib is arranged on the elastic portion.

19. The electrical outlet extender according to claim 18, wherein the fastening element defines a recess on the side wall corresponding to the elastic portion, so as to provide a sufficient space for the deformation of the elastic portion when the rotating assembly rotates relative to non-rotating assembly.

20. The electrical outlet extender according to claim 17, wherein each of the plurality of recessed portions comprises a first end and a second end, an angle defined by a line connecting the first end and a center of the frame and a line connecting the second end and the center of the frame ranges from 3° to 6°.
